(19) United States
(12) Patent Application Publication
(10) Pub. No.: US 2024/0156099 A1
(43) Pub. Date: May 16, 2024

(54) COMPOSITION FOR GENERATION OF CHLORINE DIOXIDE FOR USE AS SANITIZER

(71) Applicant: ZANINI ADMINISTRADORA DE BENS LTDA EPP, LONDRINA (BR)

(72) Inventor: Maria Elisabeth Paschoal Sodre, Londrina (BR)

(21) Appl. No.: 18/238,883

(22) Filed: Aug. 28, 2023

(30) Foreign Application Priority Data
Aug. 26, 2022 (BR) 1020220172188

(51) Int. Cl. A01N 59/00; A01N 25/02; A01P 1/00

(52) U.S. Cl. CPC A01N 59/00; A01N 25/02; A01P 1/00

(57) ABSTRACT

COMPOSITION FOR GENERATION OF CHLORINE DIOXIDE FOR USE AS SANITIZER, PATENT FOR THE INVENTION OF A COMPOSITION OF CHEMICAL PRODUCTS, TO BE USED AS A SANITIZING AGENT FOR DISINFECTION OF WATER, SURFACES, EQUIPMENT AND ENVIRONMENTS, GENERATING SOLUTION, COMPOSED OF Sodium Bisulfate—10-60%; Trichlorisocyanuric Acid—5-25%; Magnesium Sulfate—1-10%; Sodium Chlorite—20-60%; and optionally: Polyvinylpyrrolidone; Dichlorisocyanuric Acid; Sodium Chloride; Dyes; Citric acid; Fumaric Acid; Malic Acid; Calcium Chloride. The products can be separated into two or more groups or mixed into a single powder, in the form of a tablet, or aqueous solution. It consists of the high content of Chlorine Dioxide generation, generating 10-30% of Chlorine Dioxide in relation to the mass of the mixture, resulting in facilities and speed in reaching the maximum concentration.

This application takes priority from and claims the benefit of Brazilian Patent Application No. 1020220172188 filed on Aug. 26, 2022, the contents of which are herein incorporated by reference.

Refers to the present patent of invention of “COMPOSITION FOR GENERATION OF CHLORINE DIOXIDE FOR USE AS SANITIZER”, of a composition of chemical products, under a design with technological and functional improvements, used as a sanitizing agent for disinfection of water for human, industrial and agricultural use, as a sanitizer, for use in agriculture, poultry, swine, fish farming, hospitals, food industry, refrigerators, slaughterhouses, swimming pools, food and beverage, hospitality, household sanitizer, sanitary, etc.

Chlorine dioxide is a strong oxidizing agent released in water, with excellent sterilization capacity, in a wide pH range and over a wide spectrum of microorganisms, and can be used to kill bacteria, viruses and break down proteins into amino acids and other reducing substances, it can also react with organic matter and inorganic ion.

Chlorine dioxide, unlike chlorine, does not produce organochlorine compounds such as chloramines and trihalomethanes, haloacetic acids, which favor mutations and are carcinogenic, chlorine dioxide is classified by the World Health Organization (WHO) in safety level A1.

The various uses of chlorine dioxide also indicate for use as a bleaching agent in cellulose industries, weaving, disinfection of food and beverages, disinfection in chillers of cooling of poultry and pigs, disinfection of surfaces, disinfection of food packaging, conservation of meats, fruits and vegetables, health area, treatment of swimming pools, prevention of epidemics, and also as an air purification agent indoors, agricultural and livestock facilities, toilets, automobiles, as algaecide of industrial water treatment, drinking water treatment, sewage treatment and water treatment agent in general.

As it is an unstable gas, chlorine dioxide is difficult to keep compressed due to the high risk of explosion and cannot be transported or stored, which greatly limits its use. Chlorine dioxide solutions are stable only at low concentrations, which makes it impossible to commercialize them in liquid form. Thus, the uses of chlorine dioxide currently occur by the generation “in loco” through generators with high cost of acquisition, operation and maintenance, making its application in low and medium consumptions preventive.

Regardless of being in gaseous or liquid form, its use brings many drawbacks in transportation, storage, dosing and use in general, with this limitation, the product of the solid form (powder or tablet) for generation of the solution “in loco” brings a number of advantages.

Thus, the purpose of the present invention is to remedy the deficiency existing in the inconveniences pointed out above, which exist in the disinfection agent due to stability problems of the forms of generation, yield, safety, storage and transportation, of the disinfectant chlorine dioxide.

In the market are found chlorine dioxide generators that, in general, perform the dosage and mixture of chlorite or chlorate of sodium with an acidifying agent, usually sulfuric acid or hydrochloric acid. This type of equipment demands a high investment cost and the dosed products, in general, in liquid form, are dangerous to human health and require users to have a series of environmental and safety licenses due to the high degree of risk of their use.

Ready-to-use liquid chlorine dioxide compositions are still on the market. This type of product carries in itself the difficulty, inherent in chlorine dioxide gas, of obtaining stable solutions above the concentration of 1%. Thus, the logistical cost of this type of product hinders and/or even makes its use unfeasible, since most of the product is water.

In the international market there are solid, powdered and bicomponent compositions.

In Brazil, the patent BR 102014016211-9 (rejected), deals with compositions and method of preparation for the generation of chlorine dioxide for various purposes, comprising, more precisely, the combination of mixtures of inorganic salts proportionally balanced and individually packaged or pressed in the form of a tablet that allows the resulting product, when diluted in water, to develop the necessary reactions and lead to the formation of chlorine dioxide for almost immediate use.

The solid form that seems to be the most promising for small and medium consumptions, being possible the generation on demand. Many companies have focused on the development of solid formulations seeking to have the highest yield with the lowest mass of product in order to enable the cost of generation and optimize the cost of transportation and storage.

The compaction process for the manufacture of tablets, effervescent or not, limits the generation content of Chlorine Dioxide by the risk of explosion when the precursor products are subjected to pressure. In the international and national market there are no commercial products in the form of tablets available with generation above 12% of Chlorine Dioxide, however, there are patents that through specific treatment of the active principles can generate up to 30% of Chlorine Dioxide.

In view of the efficiency of powdered products, resulting in improvements in the state of the art, the present invention patent seeks such a solution by creating a solid, safe, high-performance formulation that, when mixed with water, generates a solution containing chlorine dioxide, which can be used for various disinfection purposes. This formulation shall contain the following products:
Sodium Bisulfate—10-60%
Trichlorisocyanuric Acid—5-25%
Magnesium Sulfate—1-10%
Sodium Chlorite—20-60%

The compositions of the invention may optionally contain the following products:
Polyvinylpyrrolidone;
Dichloro isocyanuric acid;
Sodium chloride;
Dyes;
Citric acid;
Fumaric acid;
Malic Acid;
Calcium chloride.

Products can be separated into two or more groups or packages, mixed into a single powder or pressed in the form of a tablet.

### BRIEF DESCRIPTION OF THE DRAWINGS

FIG. 1 illustrates a chemical equation demonstrating when an equilibrium is reached between cyanuric acid and its main dissociation products.

FIG. 2.1 illustrates a chemical reaction of the final product composed of precursor salt in the form of sodium chlorite.

FIG. 2.2 illustrates a chemical reaction wherein the available free chlorine molecules react with chlorite, considerably increasing the yield, leaving as a by-product only “salt” (sodium chloride) and water.

The inventive feature of the invention patent COMPOSITION FOR GENERATION OF CHLORINE DIOXIDE FOR USE AS A SANITIZER, consists of the high content of generation of Chlorine Dioxide, being able to generate 10-30% of Chlorine Dioxide in relation to the mass of the mixture, resulting in ease of application, safety and feasibility of costs.

Another point to highlight is the speed in reaching the maximum concentration of Chlorine Dioxide generated. The maximum point of concentration will be reached in about 15 minutes, and in general a maximum of 30 minutes, preferably less.

The product consists of a source of chlorite anion, such as an alkali or alkaline-earth metal chlorite, preferably sodium chlorite, and one or more sources of dry solid acid, which may include salts of inorganic acid, such as sodium acid sulfate, potassium acid sulfate, and potassium dihydrogen phosphate; or organic acids, such as citric, malic or fumaric acid and their mixtures. Preferably, the solid acid source is a source of solid inorganic acid such as sodium dihydrogenophosphate (sodium bisulfate).

The product may also include ingredients, but are not limited to excipients such as sodium chloride, stabilizers such as magnesium sulfate, tinctures, pigments or dyes, desiccanting agents such as calcium chloride and magnesium sulfate. Effervescent agents, such as baking soda, can be included in small amounts, accelerating the dissolution of the product, but can reduce the conversion of the chlorite anion into chlorine dioxide.

In addition, a source of free halogen can be added in the form of a chemical compound of the isocyanuric family in acid form, such as dichloroisocyanuric acid or trichloroisocyanuric acid. This halogen allows the conversion of the anion into chlorine dioxide to be increased, with a yield of at least and not limited to 60% by mass of the chlorite precursor salt. Depending on the mass balance between the salt, the source of solid acid, excipients and free halogen, this conversion can be increased up to 90% into chlorine dioxide when in contact with aqueous medium, whether this medium is clean or not.

The mechanism of action of the free halogen in the formulation of the product is widely discussed, and in theory depends on the synergy of all the other chemical components present, as well as the mass balance between them. With this, the chlorine dioxide solution is produced quickly in a safe and controlled manner.

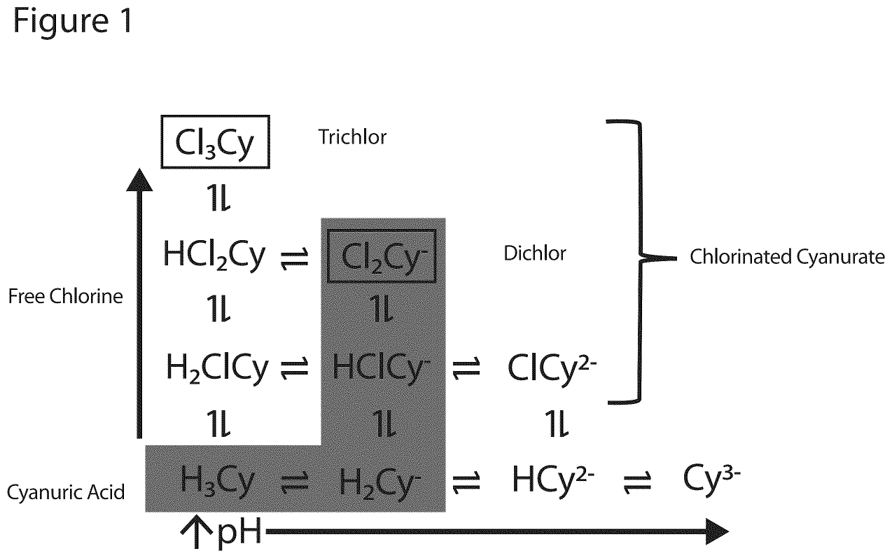

In the case of the use of a free halogen source, a possible mechanism to elucidate the increase in chlorine dioxide yield, is directly related to how the acidic form of dichloroisocyanuric or trichloroisocyanuric, upon contact with water, comes into equilibrium. The equilibrium (FIG. 1) is reached between cyanuric acid and its main dissociation products, such as free chlorine and chlorinated cyanurates, making them available in the aqueous medium, and this reaction can happen in a few seconds (Wahman, 2019).

In the proposed mechanism we have the greatest availability of free chlorine with the decrease in pH, or even chlorine in the form of hypochlorous acid.

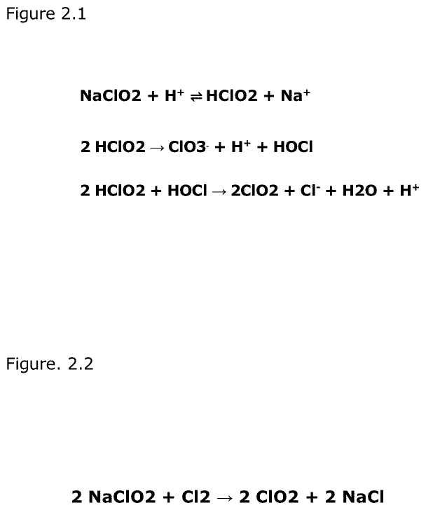

The reaction of the final product composed of precursor salt in the form of sodium chlorite, for example, in the presence of an acidic medium, such as sodium bisulfate, occurs in general, as shown in FIG. 2.1.

As the addition of a free halogen provides the availability of hypochlorous acid chlorine after dissociation at acidic pH, it is likely that the displacement of the reaction occurs in the direction of formation of chlorine dioxide and still according to another possible mechanism, the available free chlorine molecules react with chlorite, considerably increasing the yield, leaving as a by-product only “salt” (sodium chloride) and water, as shown in FIG. 2.2.

In general, the reactions elucidated above occur simultaneously between the components of the formulation and require between 30 seconds to about 30 minutes for full generation of the chlorine dioxide gas that is dissolved in the water in equilibrium. The reaction time will be different depending on the medium to be generated and the possible interferents that may be dissolved in this medium, in addition to the temperature.

It should also be considered that changes in the proportions of the formulation of the product and or even removal or insertion of compounds can cause significant conversion losses, which are not desired in the process of obtaining “in loco” chlorine dioxide.

The product can be packaged in two separate components, A and B, in previously established doses in order to facilitate the use and ensure greater safety. However, the bulk presentation should also be included in the inventive aspect, as well as single inserts (with component A+component B) or inserts of component A separately from the insert of component B, in addition to aqueous solutions based on the composition of the present invention.

### SUMMARY

“COMPOSITION FOR GENERATION OF CHLORINE DIOXIDE FOR USE AS SANITIZER”, PATENT FOR THE INVENTION OF A COMPOSITION OF CHEMICAL PRODUCTS, TO BE USED AS A SANITIZING AGENT FOR DISINFECTION OF WATER, SURFACES, EQUIPMENT AND ENVIRONMENTS, GENERATING SOLUTION, COMPOSED OF Sodium Bisulfate—10-60%; Trichlorisocyanuric Acid—5-25%; Magnesium Sulfate—1-10%; Sodium Chlorite—20-60%; and optionally: Polyvinylpyrrolidone; Dichlorisocyanuric Acid; Sodium Chloride; Dyes; Citric acid; Fumaric Acid; Malic Acid; Calcium Chloride. The products can be separated into two or more groups or mixed into a single powder, in the form of a tablet, or aqueous solution. It consists of the high content of Chlorine Dioxide generation, generating 10-30% of Chlorine Dioxide in relation to the mass of the mixture, resulting in facilities and speed in reaching the maximum concentration. In the composition we have the greatest availability of free chlorine with the decrease of pH, or even chlorine in the form of hypochlorous acid, the reaction of the final product composed of precursor salt in the form of sodium chlorite, in the presence of an acidic medium, such as sodium bisulfate, as the addition of a free halogen provides the availability of hypochlorous acid chlorine after dissociation in acidic pH, the displacement of the reaction occurs in the direction of formation of chlorine dioxide and still according to another possible mechanism, the available free chlorine molecules that react with the chlorite, increasing the yield, leaving as a by-product only “salt” (sodium chloride) and water: 2NaClO2+Cl2→2ClO2+2NaCl. The reactions occur simultaneously between the components of the formulation and require between 30 seconds to about 30 minutes for full generation of the chlorine dioxide gas that is dissolved in the water in equilibrium.

The product packaged in two separate components, A and B, in previously established doses in order to facilitate use and ensure greater safety. The bulk presentation also included in the inventive aspect or single inserts (with component A+component B) or inserts of component A separately from the insert of component B.

What is claimed is:

1. COMPOSITION FOR GENERATION OF CHLORINE DIOXIDE FOR USE AS SANITIZER”, characterized by a composition of chemicals, used as a sanitizer, for disinfection of water, surfaces, equipment and environments, generating solution, composed of Sodium Bisulfate—10 60%; Trichlorisocyanuric Acid—5-25%; Magnesium Sulfate—1-10%; Sodium Chlorite—20-60%; and optionally: Polyvinylpyrrolidone; Dichlorisocyanuric Acid; Sodium Chloride; Dyes; Citric acid; Fumaric Acid; Malic Acid; Calcium Chloride, the products can be separated into two or more groups or mixed in a single powder, in the form of a tablet, or aqueous solution, consisting of the high content of Chlorine Dioxide generation, generating 10-30% of Chlorine Dioxide in relation to the mass of the mixture, resulting in ease and speed in reaching the maximum concentration, having the greatest availability of free chlorine with the decrease in pH, or even chlorine in the form of hypochlorous acid, the reaction of the final product composed of precursor salt in the form of sodium chlorite, in the presence of an acidic medium, such as sodium bisulfate, as the addition of a free halogen provides the availability of hypochlorous acid chlorine after dissociation in acidic pH, the displacement of the reaction occurs in the direction of the formation of chlorine dioxide and still according to another possible mechanism, the available free chlorine molecules that react with the chlorite, increasing the yield, leaving as a by-product only “salt” (sodium chloride) and water: 2NaClO2+Cl2→2ClO2+2NaCl. The reactions occur simultaneously between the components of the formulation and require between 30 seconds to about 30 minutes for full generation of the chlorine dioxide gas that is dissolved in the water in equilibrium. The product packaged in two separate components, A and B, in previously established doses in order to facilitate use and ensure safety. The bulk presentation also included in the inventive aspect or single inserts (with component A+component B) or inserts of component A separately from the insert of component B.
